(19) United States
(12) Patent Application Publication
(10) Pub. No.: US 2025/0390344 A1
(43) Pub. Date: Dec. 25, 2025

(54) JOB SCHEDULING METHOD AND INFORMATION PROCESSING APPARATUS

(71) Applicant: Fujitsu Limited, Kawasaki-shi (JP)

(72) Inventor: Hiroyuki KOBAYASHI, Kawasaki (JP)

(73) Assignee: Fujitsu Limited, Kawasaki-shi (JP)

(21) Appl. No.: 19/317,063

(22) Filed: Sep. 2, 2025

Related U.S. Application Data
(63) Continuation of application No. PCT/JP2024/003028, filed on Jan. 31, 2024.

(30) Foreign Application Priority Data
Mar. 9, 2023 (JP) 2023-036387

(51) Int. Cl. G06F 9/48; G06F 8/65

(52) U.S. Cl. CPC G06F 9/4887; G06F 8/65

(57) ABSTRACT

An information processing apparatus identifies, from among a plurality of execution waiting jobs, an update job for updating control software on a target node and a user job specifying the number of nodes to be used indicating how many nodes to use. The information processing apparatus calculates a possible start time at which the number of idle nodes having the same version becomes greater than or equal to the number of nodes to be used, based on the versions of the control software on the plurality of nodes and the scheduled end times of running jobs. The information processing apparatus determines, based on a processing time needed to execute the update job and the possible start time, whether to prioritize execution of the update job or the user job.

### CROSS-REFERENCE TO RELATED APPLICATIONS

This application is a continuation application of International Application PCT/JP2024/003028 filed on Jan. 31, 2024, which designated the U.S., which is based upon and claims the benefit of priority of the prior Japanese Patent Application No. 2023-036387, filed on Mar. 9, 2023, the entire contents of which are incorporated herein by reference.

### FIELD

The embodiments discussed herein relate to a job scheduling method and an information processing apparatus.

### BACKGROUND

One form of information processing system is a parallel processing system that includes a plurality of nodes capable of executing threads in parallel. The parallel processing system may be designed to accept, from a user, a user job with specification of the number of nodes to be used, and allocate the specified number of idle nodes to the user job to execute the user job. If the specified number of idle nodes are not available, the parallel processing system registers the user job in an execution waiting queue and waits until the specified number of idle nodes are available. In view of the waiting time of the user job, the utilization efficiency of the nodes, and others, the parallel processing system allocates nodes to a plurality of user jobs according to an appropriate scheduling algorithm.

A system has been proposed in which kernel codes are dynamically modified during the operation of an operating system (OS) that performs virtual storage management. In addition, a patch application method has been proposed in which computers in a slave state are selected one by one from among a plurality of computers included in a cluster system, and are instructed for patch application of an OS, thereby preventing two or more slave computers from simultaneously performing the patch application process.

In addition, a distributed processing system has been proposed which automatically updates OS image data used in a virtual machine. In addition, an OS update method has been proposed in which clients are divided into a plurality of groups on the basis of the number of clients, the release date of a new OS, and the support end date of an old OS, and an update schedule for each group is determined. See, for example, the following literatures.
Japanese Laid-open Patent Publication No. 2000-293362
Japanese Laid-open Patent Publication No. 2006-252437
U.S. Patent Application Publication No. 2018/0349130
U.S. Patent Application Publication No. 2020/0241868

### SUMMARY

In one aspect, there is provided a non-transitory computer-readable storage medium storing a computer program that causes a computer to perform a process including: identifying, from among a plurality of execution waiting jobs, an update job for updating control software on a target node among a plurality of nodes and a user job specifying a number of nodes to be used among the plurality of nodes; calculating, based on a version of the control software on each of the plurality of nodes and a scheduled end time of each of one or more running jobs being executed on the plurality of nodes, a possible start time at which a number of idle nodes having a same version of the control software among the plurality of nodes becomes greater than or equal to the number of nodes to be used; and determining, based on a processing time needed to execute the update job and the possible start time, whether to prioritize execution of the update job or the user job.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an information processing apparatus according to a first embodiment;

FIG. 2 illustrates an example of an information processing system according to a second embodiment;

FIG. 3 is a block diagram illustrating an example of hardware of a scheduler;

FIG. 4 is a block diagram illustrating an example of functions of the scheduler;

FIG. 5 is a block diagram illustrating an example of functions of a patching server;

FIG. 6 illustrates a first job schedule example;

FIG. 7 illustrates a second job schedule example;

FIG. 8 illustrates a third job schedule example;

FIG. 9 illustrates an example of a job table;

FIG. 10 illustrates an example of a running user job table;

FIG. 11 illustrates an example of a schedule search table;

FIG. 12 illustrates an example procedure for patch job creation;

FIG. 13 illustrates an example procedure for job reception;

FIG. 14 illustrates a first example procedure for job scheduling;

FIG. 15 illustrates the first example procedure for the job scheduling (continuation 1);

FIG. 16 illustrates the first example procedure for the job scheduling (continuation 2);

FIG. 17 illustrates a second example procedure for the job scheduling;

FIG. 18 illustrates the second example procedure for the job scheduling (continuation 1); and

FIG. 19 illustrates the second example procedure for the job scheduling (continuation 2).

### DESCRIPTION OF EMBODIMENTS

A parallel processing system may execute an update job on each of a plurality of nodes to update their control software such as an OS or middleware. Since the nodes complete their currently executing user jobs at different times, the parallel processing system may allow the update job to start on different nodes at different times.

If, however, the update job starts on different nodes at different times, user jobs registered in the parallel processing system after the update job may be kept waiting for a long time due to some nodes executing their update jobs.

Hereinafter, embodiments will be described with reference to the drawings.

### First Embodiment

A first embodiment will be described.

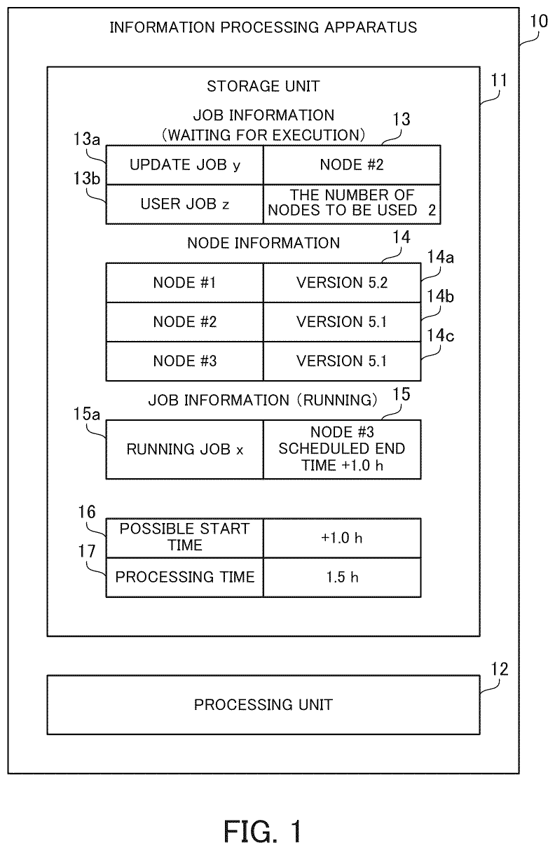

FIG. 1 is a diagram for describing an information processing apparatus according to the first embodiment.

In a parallel processing system including a plurality of nodes, the information processing apparatus 10 of the first embodiment performs job scheduling to allocate idle nodes to jobs. The information processing apparatus 10 may be a client apparatus or a server apparatus. The information processing apparatus 10 may be referred to as a computer or a job scheduler.

The information processing apparatus 10 includes a storage unit 11 and a processing unit 12. The storage unit 11 may be a volatile semiconductor memory such as a random access memory (RAM) or a non-volatile storage such as a hard disk drive (HDD) or a flash memory.

The processing unit 12 is, for example, a processor such as a central processing unit (CPU), a graphics processing unit (GPU), or a digital signal processor (DSP). Alternatively, the processing unit 12 may include an electronic circuit such as an application specific integrated circuit (ASIC) or a field programmable gate array (FPGA). The processor executes, for example, a program stored in a memory (which may be the storage unit 11) such as a RAM. The processor may be referred to as processor circuitry. A set of processors may be referred to as a multiprocessor or simply as a “processor”. Different processes among a plurality of processes to be described below may be performed by different processors.

The storage unit 11 stores job information 13 and 15 and node information 14. The job information 13 indicates a plurality of execution waiting jobs. The plurality of execution waiting jobs may be registered in an execution waiting queue and, in principle, may be arranged in order of arrival. The plurality of execution waiting jobs include an update job 13a and a user job 13b. The update job 13a may be at the top of the execution waiting queue, and the user job 13b may be placed after the update job 13a.

The update job 13a is to update control software on a target node among the plurality of nodes included in the parallel processing system. The plurality of nodes are computers that execute threads initiated by designated programs. A thread may be referred to as a process. Different nodes are able to execute different threads in parallel.

The control software is software such as an OS or middleware, which is used to execute user programs. The update job 13a upgrades the control software by, for example, applying a correction program, which reflects the update difference, to the control software. The correction program may be referred to as an update or a patch. The update job 13a is generated, for example, in response to a request from an administrator or a management computer of the parallel processing system. The information processing apparatus 10 may generate the update job 13a. An update job is generated for each node, and the update jobs for updating different nodes may be initiated at different start times. The update job 13a here updates the control software on a second node.

The user job 13b is generated in response to a request from a user or a user computer. The user job 13b specifies, for example, a user program to be executed. The user job 13b specifies the number of nodes to be used. In the case where the number of nodes to be used is two or more, for example, two or more nodes execute two or more threads initiated by the user program in parallel. The user job 13b here specifies that the number of nodes to be used is two. The user job 13b may specify a maximum execution time. If the maximum execution time has elapsed from the start time, the execution of the user job 13b may be aborted.

Assume here that the user job 13b uses two or more nodes. If the versions of the control software on the two or more nodes are different, the user job 13b may fail to be executed correctly due to differences in the behavior of the control software. Therefore, nodes with the same version of the control software are allocated to the same user job.

The node information 14 indicates the version of the control software for each of the plurality of nodes included in the parallel processing system. The version may be represented by a version number, or may be represented by a flag indicating whether a correction program has been applied.

For example, a first node has version 14a, a second node has version 14b, and a third node has version 14c. Here, the version 14a is a new version, and the versions 14b and 14c are old versions. The version of each node indicated in the node information 14 is changed by the execution of an update job. Since the update job starts at different times on each node, the version is updated at different times on each node as well.

The job information 15 indicates a scheduled end time for each of one or more running jobs including a running job 15a. The running job 15a is a job to which one or more nodes have been allocated and which has been started but not yet completed. The running job 15a may be a user job or an update job. Here, the running job 15a is executed on the third node.

The scheduled end time of a user job is calculated based on, for example, the start time, and the maximum execution time specified by the user. The scheduled end time may be obtained by adding the maximum execution time to the start time. Alternatively, the information processing apparatus 10 may estimate the scheduled end time from the type of the user job, the size of the user program, or the like with reference to a history of past user jobs.

The processing unit 12 detects the update job 13a and the user job 13b from the job information 13. The processing unit 12 calculates a possible start time 16 for the user job 13b based on the versions 14a, 14b, and 14c indicated in the node information 14 and the scheduled end time of the running job 15a indicated in the job information 15. The possible start time 16 is a time at which the number of idle nodes with the same version among the plurality of nodes becomes greater than or equal to the number of nodes to be used.

For example, while the running job 15a is currently running, the first node and the second node are idle nodes, and the third node is in use. The control software on the first node is the new version, and the control software on the second node is the old version. Therefore, before the running job 15a ends, the number of idle nodes with the same version is one, which is less than the number of nodes to be used for the user job 13b.

When the running job 15a ends, the first node, the second node, and the third node are idle nodes. The control software on the first node is the new version, and the control software on the second node and the third node is the old version. Therefore, when the running job 15a ends, the number of idle nodes with the same version becomes two, that is, the second node and the third node, which reaches the number of nodes to be used for the user job 13b. Therefore, here, the possible start time 16 is the scheduled end time of the running job 15a.

The processing unit 12 determines whether to prioritize the execution of the update job 13a or the user job 13b, based on a processing time 17 and the possible start time 16. The processing time 17 is an estimated value for the execution time of the update job 13a. In the case where an update job of the same version as the update job 13a has been executed on another target node (for example, the first node), the processing time 17 may be the measured value of the execution time taken for the other target node. In the case where any update job of the same version has not been executed, the processing time 17 may be estimated based on the content, size, or another of the update job 13a.

For example, in the case where the waiting time until the possible start time 16 is shorter than the processing time 17, if the update job 13a is executed first, the start time of the user job 13b may be delayed by waiting for the end of the update job 13a. To avoid this, the processing unit 12 may determine that the update job 13a is to be deferred and the execution of the user job 13b is to be prioritized over the update job 13a. On the other hand, in the case where the processing time 17 is shorter than the waiting time until the possible start time 16, the start time of the user job 13b is highly unlikely to be delayed even if the update job 13a is executed first. Therefore, the processing unit 12 may determine that update job 13a is to be executed preferentially over the user job 13b.

As described above, the information processing apparatus 10 of the first embodiment detects the update job 13a and the user job 13b from among a plurality of execution waiting jobs. The information processing apparatus 10 calculates the possible start time 16 at which the number of idle nodes with the same version is greater than or equal to the number of nodes to be used for the user job 13b, based on the version of the control software on each node and the scheduled end time of the running job 15a. The information processing apparatus 10 determines whether to prioritize the execution of the update job 13a or the user job 13b, based on the processing time 17 and the possible start time 16 of the update job 13a.

As a result, the update job starts on different nodes at different start times. Therefore, the availability of the parallel processing system is improved as compared to the case where the operation of the parallel processing system is temporarily stopped and the update job is executed simultaneously on all the nodes. In addition, two or more nodes with the same version of control software are allocated to the user job 13b. This ensures the correctness of the calculation result of the user job 13b.

The priority of the update job 13a is adjusted in consideration of the possible start time 16 of the user job 13b. Therefore, as compared to the case where the update job 13a and the user job 13b are simply executed in order of arrival, the delay of the user job 13b is reduced, and its waiting time is minimized.

In this connection, the priority may be determined in the case where the update job 13a is at the top of the execution waiting queue and the user job 13b is placed after the update job 13a in the execution waiting queue. By doing so, the delay of the user job 13b caused by executing the update job 13a and the user job 13b in order of arrival is reduced.

In addition, in the case where the waiting time until the possible start time 16 is shorter than the processing time 17, the information processing apparatus 10 may determine that the user job 13b is to be executed preferentially over the update job 13a. By doing so, the delay of the user job 13b caused by waiting for the end of the update job 13a is reduced.

In the case where the job information 15 includes another update job, the information processing apparatus 10 may determine idle nodes with the same version in consideration of a change in the version of another target node resulting from execution of the other update job. As a result, the possible start time 16 is accurately calculated under the constraint that idle nodes with the same version are allocated to the user job 13b.

### Second Embodiment

Next, a second embodiment will be described.

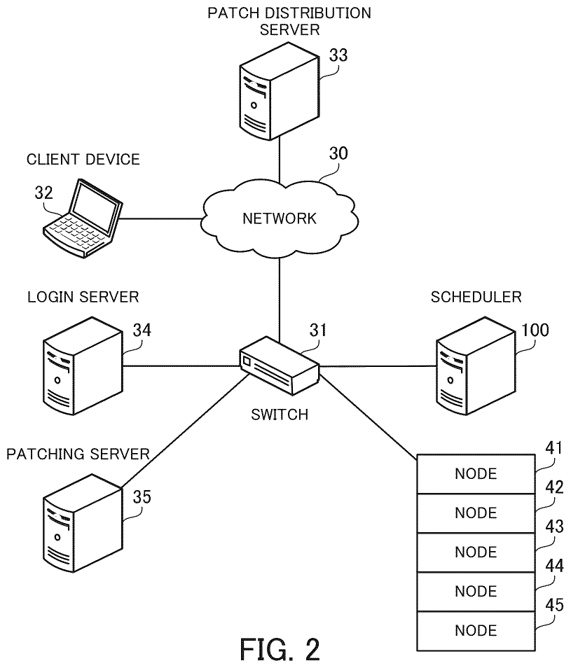

FIG. 2 illustrates an example of an information processing system according to the second embodiment.

The information processing system according to the second embodiment includes a switch 31, a client device 32, a patch distribution server 33, a login server 34, a patching server 35, a plurality of nodes including nodes 41 to 45, and a scheduler 100.

The switch 31, the client device 32, and the patch distribution server 33 are connected to a network 30. The network 30 is, for example, a wide area data communication network such as the Internet. The login server 34, the patching server 35, the nodes 41 to 45, and the scheduler 100 are connected to the switch 31. The switch 31 is a wired communication device included in a local area network (LAN). The switch 31 transfers packets. The scheduler 100 corresponds to the information processing apparatus 10 of the first embodiment.

The client device 32 is a client computer that a user of the information processing system uses. The client device 32 logs in to the login server 34 via the network 30. The client device 32 uses the login server to generate a user job request specifying a user program, the number of nodes to be used, and a maximum execution time.

The patch distribution server 33 is a server computer that distributes patches for OSs. The patches may sometimes be called correction programs or correction modules. The patch distribution server 33 receives access via the network 30. In response to the access, the patch distribution server 33 transmits a patch file, and specification information such as the version number and application requirements of the patch.

The login server 34 is a frontend server computer that receives user access. The login server 34 authenticates the client device 32. When the authentication is successful, the login server 34 receives the specifications of a user program, the number of nodes to be used, the maximum execution time, and others from the client device 32. The login server 34 generates a user job request based on these specifications and transmits the user job request to the scheduler 100.

The patching server 35 is a server computer that applies a new patch to the nodes 41 to 45. Note that the information processing system may include a client computer that an administrator uses, in place of the patching server 35. In addition, the functions of the patching server 35 may be incorporated in the scheduler 100.

The patching server 35 periodically accesses the patch distribution server 33 to determine whether a new patch has been distributed. When determining that a new patch has been distributed, the patching server 35 determines whether each node 41 to 45 satisfies the application requirements for the new patch. The patching server 35 generates a patch job request for applying the patch to a node satisfying the application requirements, and transmits the patch job request to the scheduler 100. The patch job request is generated for each node.

The nodes 41 to 45 are server computers that execute specified programs. The nodes 41 to 45 may be referred to as computing nodes. An OS has been installed on the nodes 41 to 45. The nodes 41 to 45 may be allocated to the same or different user jobs. Each node is not allocated to more than one user job at the same time. The nodes 41 to 45 may be allocated to a patch job. A node executing the patch job is not allocated to any user job until the patch job is complete.

The scheduler 100 is a server computer that performs job scheduling for allocating the nodes 41 to 45 to a plurality of jobs. The scheduler 100 receives a user job request from the login server 34 and registers the user job at the end of a waiting job list. The scheduler 100 also receives a patch job request from the patching server 35 and registers the patch job at the end of the waiting job list.

The scheduler 100 monitors the job execution status of each node 41 to 45. In principle, the scheduler 100 allocates one or more nodes to jobs, preferentially in order from the top of the waiting job list, that is, in order of arrival. In the case where a user job is placed at the top, the scheduler 100 allocates as many idle nodes as the number of nodes to be used to the user job when the number of idle nodes becomes greater than or equal to the specified number of nodes to be used. However, nodes with different OS version numbers are not allocated to the same user job. Therefore, nodes that are allocated to the user job are either nodes none of which has been patched or nodes all of which have been patched.

In the case where a patch job is placed at the top, on the other hand, the scheduler 100 causes its patch application target node to execute the patch job when the patch application target node becomes idle. Note, however, that the scheduler 100 may temporarily defer the patch job and first cause a user job that has arrived after the patch job to be executed, as will be described later.

In the case where a preceding user job is not executable due to a shortage of idle nodes, the scheduler 100 applies either an arrival time priority policy or an executability priority policy to its subsequent user job. Under the arrival time priority policy, the subsequent user job, even if it is executable, is not permitted to be executed ahead of the preceding user job that is not executable. Under the executability priority policy, the subsequent user job, if it is executable, may be executed ahead of the preceding user job that is not executable. Such execution of the subsequent user job ahead of the preceding user job is sometimes referred to as backfilling.

The scheduler 100 of the second embodiment selects the arrival time priority policy as the scheduling policy in principle. However, as will be described later, the scheduler 100 may select the executability priority policy. The scheduler 100 may selectively use these scheduling policies in accordance with an instruction from the administrator.

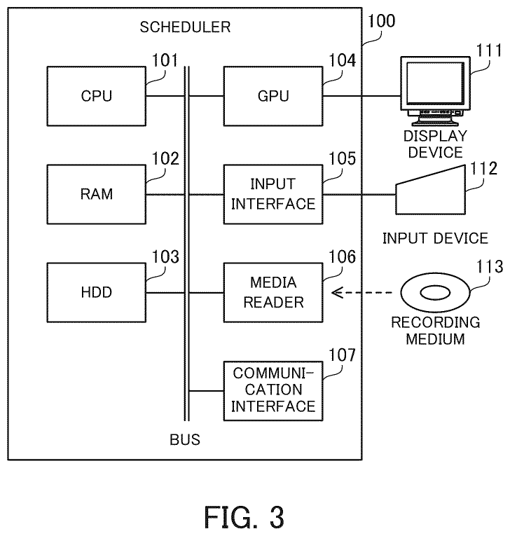

FIG. 3 is a block diagram illustrating an example of hardware of the scheduler.

The scheduler 100 includes a CPU 101, a RAM 102, an HDD 103, a GPU 104, an input interface 105, a media reader 106, and a communication interface 107, which are connected to a bus. The CPU 101 corresponds to the processing unit 12 of the first embodiment. The RAM 102 or the HDD 103 corresponds to the storage unit 11 of the first embodiment. The client device 32, the patch distribution server 33, the login server 34, the patching server 35, and the nodes 41 to 45 may have hardware similar to that of the scheduler 100.

The CPU 101 is a processor that executes program instructions. The CPU 101 loads a program and data stored in the HDD 103 into the RAM 102 and executes the program. The scheduler 100 may include a plurality of processors.

The RAM 102 is a volatile semiconductor memory that temporarily stores a program executed by the CPU 101 and data used by the CPU 101 during its operation. The scheduler 100 may have a type of volatile memory other than RAM.

The HDD 103 is a non-volatile storage that stores software programs and other data. The software includes an OS, middleware, application software, and others. The scheduler 100 may include another type of non-volatile storage such as a flash memory or a solid state drive (SSD).

The GPU 104 performs image processing in cooperation with the CPU 101, and outputs images to a display device 111 connected to the scheduler 100. The display device 111 is, for example, a cathode ray tube (CRT) display, a liquid crystal display, an organic electro luminescence (EL) display, or a projector. Other types of output devices such as a printer may be connected to the scheduler 100.

The GPU 104 may be used as a general purpose computing on graphics processing unit (GPGPU). The GPU 104 is able to execute a program in accordance with an instruction from the CPU 101. The scheduler 100 may include a volatile semiconductor memory other than the RAM 102 as a GPU memory.

The input interface 105 receives input signals from an input device 112 connected to the scheduler 100. The input device 112 is, for example, a mouse, a touch panel, or a keyboard. A plurality of input devices may be connected to the scheduler 100.

The media reader 106 is a reading device that reads a program and data recorded on a recording medium 113. The recording medium 113 is, for example, a magnetic disk, an optical disc, or a semiconductor memory. Magnetic disks include a flexible disk (FD) and an HDD. Optical discs include a compact disc (CD) and a digital versatile disc (DVD). The media reader 106 copies the program and data from the recording medium 113 to another recording medium such as the RAM 102 or the HDD 103. The read program may be executed by the CPU 101.

The recording medium 113 may be a portable recording medium. The recording medium 113 may be used for distribution of programs and data. The recording medium 113 and the HDD 103 may be referred to as computer-readable storage media.

The communication interface 107 is a wired communication interface connected to the switch 31 via a cable. The communication interface 107 communicates with the login server 34, the patching server 35, and the nodes 41 to 45 via the switch 31. In this connection, the scheduler 100 may include a wireless communication interface connected to a wireless communication device such as a base station or an access point.

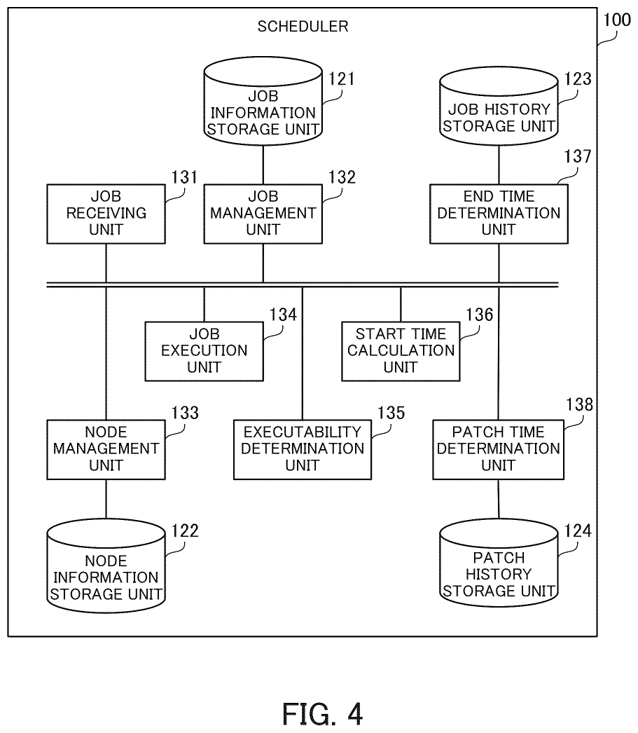

FIG. 4 is a block diagram illustrating an example of functions of the scheduler.

The scheduler 100 includes a job information storage unit 121, a node information storage unit 122, a job history storage unit 123, and a patch history storage unit 124. These storage units are implemented using, for example, the RAM 102 or the HDD 103. In addition, the scheduler 100 includes a job receiving unit 131, a job management unit 132, a node management unit 133, a job execution unit 134, an executability determination unit 135, a start time calculation unit 136, an end time determination unit 137, and a patch time determination unit 138. These processing units are implemented using, for example, the CPU 101, the communication interface 107, and a program.

The job information storage unit 121 stores information on execution waiting jobs and running jobs. The information on an execution waiting job includes a job type, the number of nodes to be used, and a processing time. The job type is either a patch job or a user job. The information on a running job includes a job type, a node to be used, a processing time, and a start time.

The node information storage unit 122 stores information indicating the current status of each node 41 to 45. The information on the current status includes the current version number of the OS. In addition, the information on the current status includes a flag indicating whether a node is an idle node. If the node is not an idle node, the information on the current status also includes the job name of a running job on the node.

The job history storage unit 123 stores an execution history of user jobs. The execution history includes job property information such as a job name and a program size. The execution history also includes a measured value of the execution time for each user job. The patch history storage unit 124 stores an execution history of patch jobs. The execution history includes patch property information such as a version number and a patch type. For example, the patch type indicates the purpose of a patch such as a function addition, a security update, or a bug correction. The execution history also includes the measured value of the execution time for each patch job.

The job receiving unit 131 receives a user job request from the login server 34. The job receiving unit 131 also receives a patch job request from the patching server 35. The job receiving unit 131 outputs the received job request to the job management unit 132.

The job management unit 132 manages information on execution waiting jobs and running jobs. The job management unit 132 acquires a job request from the job receiving unit 131, and registers a job based on the conditions specified by the job request at the end of the waiting job list. When the executability determination unit 135 determines that a certain job is executable, the job management unit 132 allocates an idle node to the job. The job management unit 132 then removes the job from the waiting job list, manages the job as a running job, and instructs the job execution unit 134 to execute the job.

The node management unit 133 collects and manages information on the current status from each node 41 to 45. The node management unit 133 may periodically access the nodes 41 to 45 to actively collect the information. Alternatively, when any of the nodes 41 to 45 starts a new job or ends a running job, the node management unit 133 may passively receive the information from the node 41 to 45.

The job execution unit 134 causes the nodes 41 to 45 to execute jobs in accordance with instructions from the job management unit 132. More specifically, the job execution unit 134 gives a notification specifying a job name, a program to be executed, and a maximum execution time, to the node allocated by the job management unit 132. The allocated node then initiates the specified program. The allocated node then ends the job when the program has halted or when the maximum execution time has been reached.

The executability determination unit 135 determines whether an execution waiting job registered in the waiting job list is executable. In the case of a user job, the executability determination unit 135 determines that the user job is executable when the number of idle nodes with the same OS version number is greater than or equal to the number of nodes to be used. In the case of a patch job, the executability determination unit 135 determines that the patch job is executable when its patch application target node is idle. Note, however, that the executability determination unit 135 may determine that an executable patch job is to be temporarily deferred, as will be described later.

The start time calculation unit 136 calculates the earliest possible start time for an execution waiting user job, on the basis of the information on running jobs and the information on the current status of the nodes 41 to 45. In the case where a certain user job is currently not executable, the user job becomes executable by waiting for the end of other running user jobs or patch jobs. The earliest possible start time is an estimated value of a time at which the user job becomes executable at the earliest in the case where execution waiting patch jobs are deferred. The possible start time may be represented as an absolute time, may be represented as an elapsed time from a reference time, or may be represented as a remaining time from the present time.

The end time determination unit 137 determines the end time of a running user job. In principle, the end time determination unit 137 calculates the end time by adding the maximum execution time to the start time. Note that the end time determination unit 137 may estimate the execution time with reference to the execution history of past user jobs. For example, the end time determination unit 137 estimates the execution time of the user job on the basis of the average execution time of past user jobs with similar job names.

In addition, for example, the end time determination unit 137 estimates the execution time on the basis of the size of the user program. Alternatively, the end time determination unit 137 may estimate the execution time by acquiring the progress of the user job from the nodes allocated to the user job. Examples of information on the progress include the executed amount of the program and the processed amount of data. The end time may be represented as an absolute time, may be represented as an elapsed time from a reference time, or may be represented as a remaining time from the present time.

The patch time determination unit 138 determines the processing time of an execution waiting patch job. If a patch of a certain version number has not been applied to any node, the patch time determination unit 138 estimates the processing time with reference to the execution history of past patch jobs. For example, the patch time determination unit 138 estimates the processing time of the patch job on the basis of the average execution time of past patch jobs with the same patch type as the patch job. If the patch of the certain version number has been applied to at least one node, the patch time determination unit 138 uses the execution times of the past patch jobs of the same version number.

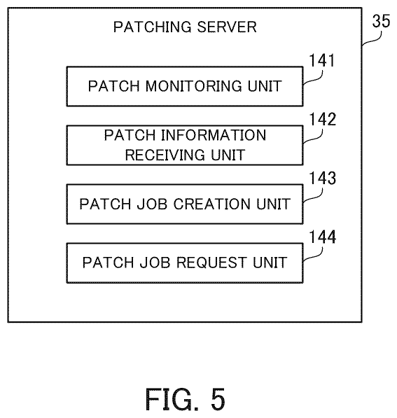

FIG. 5 is a block diagram illustrating an example of functions of the patching server.

The patching server 35 includes a patch monitoring unit 141, a patch information receiving unit 142, a patch job creation unit 143, and a patch job request unit 144. These processing units are implemented using, for example, a CPU, a communication interface, and a program.

The patch monitoring unit 141 periodically accesses the patch distribution server 33 to determine whether the patch distribution server 33 has started to distribute a new patch.

If the patch monitoring unit 141 has detected a new patch, the patch information receiving unit 142 receives specification information from the patch distribution server 33. The patch information receiving unit 142 determines whether each of the nodes 41 to 45 satisfies the application requirements. The application requirements include hardware requirements indicating specific hardware for a node and software requirements indicating a specific version number of software.

With respect to each node satisfying the application requirements, the patch job creation unit 143 creates a patch job request to apply the new patch. The patch job request specifies nodes to which the patch is to be applied and a patch file. The patch file may be received by the patching server 35 or may be received by individual nodes.

The patch job request unit 144 transmits the patch job request created by the patch job creation unit 143 to the scheduler 100.

Next, job scheduling will be described.

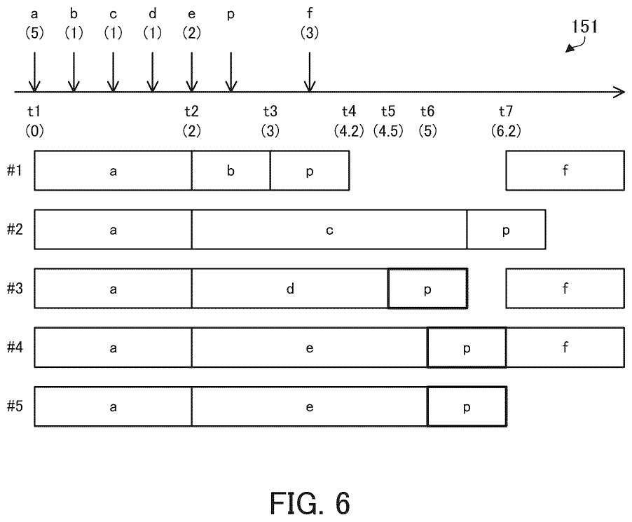

FIG. 6 illustrates a first job schedule example.

Here, it is assumed that user jobs and a patch job are executed in order of arrival regardless of patch type. A graph 151 represents an example of a job schedule in this case.

The scheduler 100 receives a user job a at time t1. Time t1 is the reference time and represents 0 hour (0 h). For the user job a, the number of nodes to be used is 5, and the execution time is 2 hours. The scheduler 100 allocates the nodes 41 to 45 to the user job a.

The scheduler 100 sequentially receives user jobs b, c, d, and e by time t2. For the user job b, the number of nodes to be used is 1, and the execution time is 1 hour. For the user job c, the number of nodes to be used is 1, and the execution time is 3.5 hours. For the user job d, the number of nodes to be used is 1, and the execution time is 2.5 hours. For the user job e, the number of nodes to be used is 2, and the execution time is 3 hours. Time t2 represents 2 hours (2 h). Since the nodes 41 to 45 are in use until time t2, the user jobs b, c, d, and e are in an execution waiting state.

At time t2, the nodes 41 to 45 become idle nodes. The scheduler 100 allocates the node 41 to the user job b, allocates the node 42 to the user job c, allocates the node 43 to the user job d, and allocates the nodes 44 and 45 to the user job e. The scheduler 100 receives a patch job p to be applied to the nodes 41 to 45 by time t3 (3 h). The execution time of the patch job p is 1.2 hours. Since the nodes 41 to 45 are in use until time t3, the patch job p is in an execution waiting state.

At time t3, the node 41 becomes an idle node. Since the patch job p is at the top of the waiting job list, the scheduler 100 causes the node 41 to execute the patch job p. The scheduler 100 receives a user job f by time t4. For the user job f, the number of nodes to be used is 3, and the execution time is 2 hours. Time t4 represents 4.2 hours (4.2 h). Since the nodes 41 to 45 are in use until time t4, the patch job p for the nodes 42 to 45 and the user job f are in an execution waiting state.

At time t4, the node 41 becomes an idle node. However, since the node 41 has been patched and there is only one idle node that has been patched, there is no job that is executable using the node 41. At time t5, the node 43 becomes an idle node. Time t5 represents 4.5 hours (4.5 h). Here, since the patch job p is at the top of the waiting job list, the scheduler 100 causes the node 43 to execute the patch job p.

At time t6, the nodes 44 and 45 become idle nodes. Time t6 represents 5 hours (5 h). Here, since the patch job p is at the top of the waiting job list, the scheduler 100 causes the nodes 44 and 45 to execute the patch job p. Thereafter, the nodes 42 and 43 become idle nodes. The scheduler 100 causes the node 42 to execute the patch job p. Since the node 43 has been patched and there are only two idle nodes that have been patched, there is no job that is executable using the node 43.

At time t7, the nodes 44 and 45 become idle nodes. Time t7 represents 6.2 hours (6.2 h). Since the nodes 44 and 45 have been patched and there are four idle nodes that have been patched, the scheduler 100 allocates three of the nodes 41 and 43 to 45 to the user job f. For example, the scheduler 100 allocates the nodes 41, 43, and 44 to the user job f. Thereafter, the patch job p on the node 42 ends, and the user jobs f on the nodes 41, 43, and 44 end.

If the patch job p does not exist, the user job f is able to start at time t6. However, in the above example, the patch job p arrives at the scheduler 100 earlier than the user job f. Therefore, the start of the user job f is delayed until time t7, and the waiting time is 1.2 hours longer. The patch to be applied to the nodes 41 to 45 by the patch job p is not necessarily a patch with a high level of urgency. However, the waiting time of the user job subsequent to the patch job may increase, as described above.

To avoid this, the scheduler 100 calculates the earliest possible start time for a user job subsequent to a patch job, and determines whether to preferentially execute the subsequent user job, on the basis of the relationship between the earliest possible start time and the processing time of the patch job. If the waiting time until the earliest possible start time is shorter than the processing time, the scheduler 100 shortens the waiting time for the subsequent user job by deferring the patch job. On the other hand, if the waiting time until the earliest possible start time is greater than or equal to the processing time, this means that the execution of the patch job would not affect the subsequent user job. Therefore, the scheduler 100 initiates the patch job before the subsequent user job.

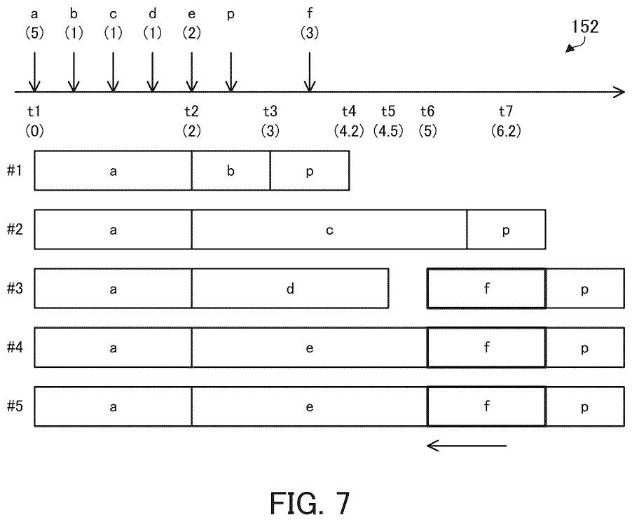

FIG. 7 illustrates a second job schedule example.

Here, consider a case where the scheduler 100 temporarily defers a patch job that has arrived earlier than a user job. A graph 152 represents an example of a job schedule in this case. The arrival times of the user jobs a, b, c, d, e, and f and the patch job p and the job schedule up to time t5 are the same as those in the graph 151.

At time t5, the node 43 becomes an idle node. At time t5, the node 41 is only one node that is idle and has been patched, and the node 43 is only one node that is idle and has not been patched. Therefore, the user job f is not executable at time t5. Note that the nodes 44 and 45 are scheduled to become idle nodes at time t6. Then, three nodes 43 to 45 are idle nodes that have not been patched, that is, the user job f is executable.

At time t5, the scheduler 100 calculates the earliest possible start time for the user job f subsequent to the patch job p as time t6. The scheduler 100 compares 0.5 hours, which is the waiting time from time t5 to time t6, with 1.2 hours, which is the processing time of the patch job p, and determines that the former is shorter. Therefore, the scheduler 100 defers the patch job p for the node 43.

At time t6, the nodes 44 and 45 become idle nodes. At time t6, the node 41 is only one node that is idle and has been patched, and three nodes 43 to 45 are idle and have not been patched. At time t6, the user job f is executable. Therefore, the scheduler 100 defers the patch job p for the nodes 44 and 45, and allocates the nodes 43 to 45 to the user job f.

When the user job c ends and the node 42 becomes an idle node thereafter, the scheduler 100 causes the node 42 to execute the patch job p. When the user job f ends and the nodes 43 to 45 become idle nodes, the scheduler 100 causes each of the nodes 43 to 45 to execute the patch job p. In this way, compared to the case of the graph 151, the start time of the user job f has advanced from time t7 to time t6.

In the case where the urgency level of the patch to be applied to the nodes 41 to 45 by the patch job p is high, as in the case of a security update patch, the scheduler 100 may initiate the patch job p preferentially over the subsequent user job f. Further, depending on the situation, prioritizing the execution of the patch job p on some nodes to increase the number of patched nodes may lead to an earlier earliest possible start time, compared to the case of deferring the patch job p on all remaining nodes.

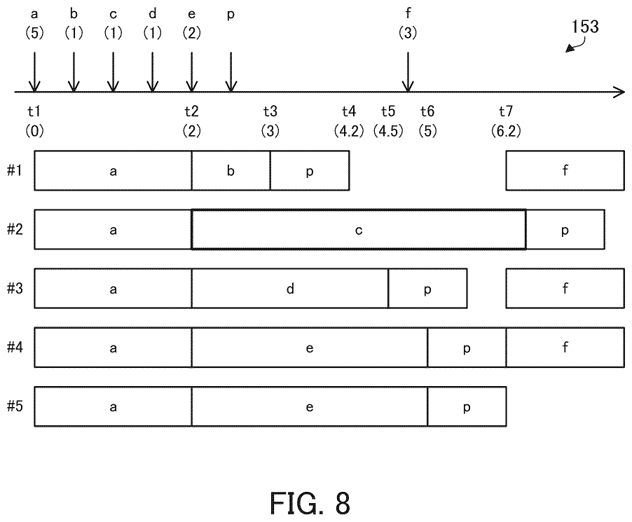

FIG. 8 illustrates a third job schedule example.

Here, as in the graph 152, consider a case where the scheduler 100 temporarily defers a patch job that has arrived earlier than a user job. A graph 153 represents an example of a job schedule in this case. The execution time of the user job c is extended from 3.5 hours to 4.5 hours. Further, the arrival time of the user job f is delayed from a time between time t3 and time t4 to a time between time t5 and time t6.

Since the user job f has not yet arrived at time t5, the scheduler 100 causes the node 43 to execute the patch job p. At time t6, the nodes 44 and 45 become idle nodes. Here, in the case of securing three unpatched idle nodes, the scheduler 100 defers the patch job p for the nodes 44 and 45 and waits until the node 42 becomes an idle node. In this case, the possible start time is 6.5 hours (6.5 h).

On the other hand, in the case of securing three or more idle patched nodes, the scheduler 100 causes the nodes 44 and 45 to execute the patch job p, and waits until the nodes 44 and 45 become idle nodes. The possible start time in this case is time t7. Therefore, the earliest possible start time for the user job f is time t7, and the scheduler 100 starts the patch job p for the nodes 44 and 45 before the user job f, without deferring the patch job p.

Note that the job schedule represented by the graph 153 is achievable within the scope of the scheduling algorithm described in the graph 152. When the patch job p for all unpatched nodes is deferred at time t6, it is possible to secure up to two idle nodes that have been patched and to secure up to three idle nodes that has not been patched. Therefore, at time t6, the scheduler 100 determines that 6.5 hours, at which the nodes 42, 44, and 45 become idle nodes, is the earliest possible start time for the user job f.

Since the waiting time until the earliest possible start time is longer than the processing time of the patch job p, the scheduler 100 causes the nodes 44 and 45 to execute the patch job p. At time t7, the nodes 44 and 45 become idle nodes. At time t7, the nodes 41 and 43 to 45 are idle nodes that have already been patched. Therefore, the user job f is executable. The scheduler 100 allocates the nodes 41, 43, and 44 to the user job f. As a result, the user job f is executed earlier than the earliest possible start time estimated at time t6. Note that, at time t6, the scheduler 100 may calculate the earliest possible start time as time t7 by considering a pattern in which the patch job p is executed on some nodes in advance.

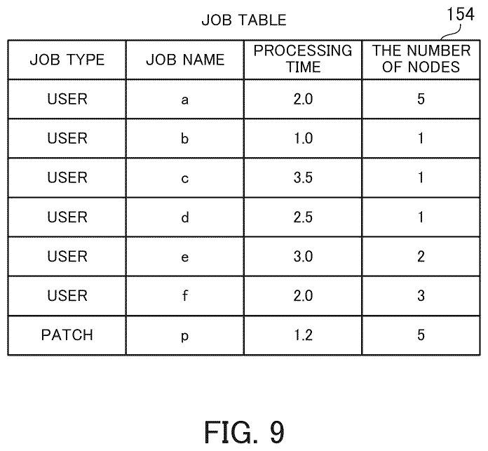

FIG. 9 illustrates an example of a job table.

A job table 154 is stored in the job information storage unit 121. The job table 154 includes a plurality of records that each include a job type, a job name, a processing time, and the number of nodes. One record corresponds to one job. Here, for the sake of simplicity, a patch job for a plurality of nodes is represented by one record.

The job type indicates a user job or a patch job. The job name is an identifier identifying a job. The processing time is an estimated value for the execution time of the job. The processing time of a user job is, for example, a maximum execution time specified by the user. The processing time of a patch job is, for example, an execution time obtained by applying the patch to a node for the first time. In the case where there is no node to which the patch has been applied, however, the processing time of the patch job is set to the execution time of a past patch job of the same type. The number of nodes refers to the number of nodes to be used for the job. The number of nodes for a user job is the number of nodes to be used, which is specified by the user. The number of nodes for a patch job is the number of nodes to which the patch is yet to be applied among the nodes to which the patch needs to be applied.

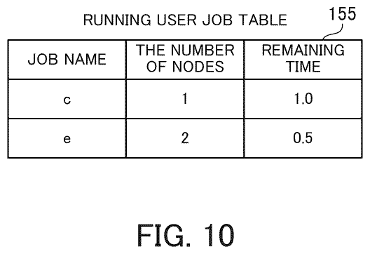

FIG. 10 illustrates an example of a running user job table.

A running user job table 155 is stored in the job information storage unit 121. The running user job table 155 includes a plurality of records that each include a job name, the number of nodes, and a remaining time. One record corresponds to one user job.

The job name is an identifier identifying a user job. The number of nodes refers to the number of nodes allocated to the user job. The remaining time is a time from the present time to the scheduled end time. The scheduled end time is a time obtained by adding the processing time to the start time.

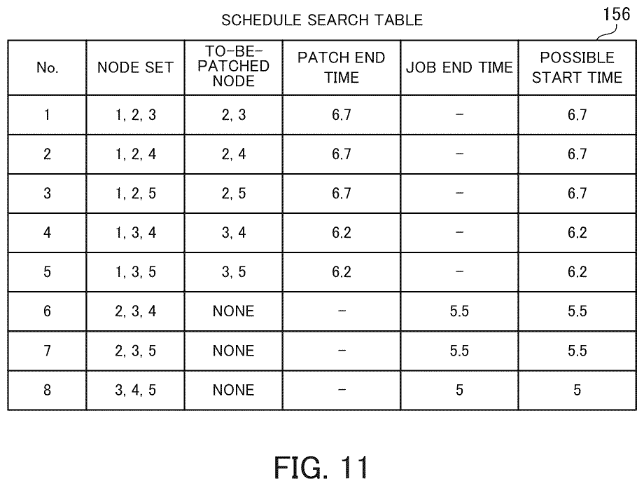

FIG. 11 illustrates an example of a schedule search table.

A schedule search table 156 may be generated by the start time calculation unit 136. The schedule search table 156 is used for calculating the earliest possible start time for a user job. As an example, the schedule search table 156 of FIG. 11 is for calculating the earliest possible start time for the user job f at time t5 of the graph 152.

The schedule search table 156 includes a plurality of records that each include a pattern number, a node set, a to-be-patched node, a patch end time, a job end time, and a possible start time. One record corresponds to one pattern of nodes allocated to a user job.

The pattern number is an identification number identifying a pattern. The node set is a combination of nodes to be allocated to a user job. The node set includes as many nodes as needed for the user job. In the case where the node set includes both one or more patched nodes and one or more unpatched nodes, the to-be-patched nodes refer to the unpatched nodes in the node set. A node currently executing a patch job is classified as a patched node. In the case where the node set includes only patched nodes or only unpatched nodes, none is set as the to-be-patched node.

The patch end time is the scheduled end time of a patch job that ends last in the case where the patch job is executed on the to-be-patched nodes. The job end time is the scheduled end time of a job that ends last among the running jobs currently executed on the node set. The running jobs include both user jobs and patch jobs. The possible start time is the later of the patch end time and the job end time. The earliest possible start time among the possible start times listed in the schedule search table 156 is the earliest possible start time of the user job.

Next, a processing procedure of the information processing system will be described.

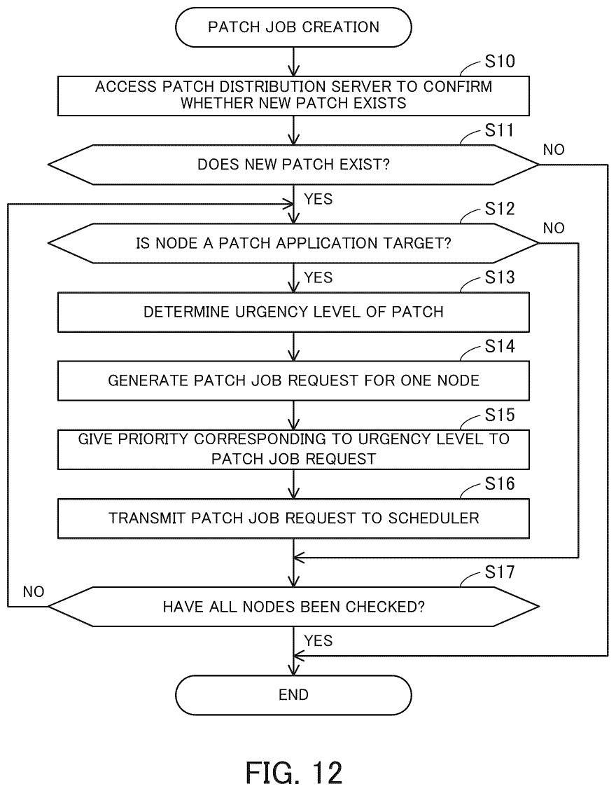

FIG. 12 illustrates an example procedure for patch job creation.

(S10) The patch monitoring unit 141 accesses the patch distribution server 33 to confirm whether the patch distribution server 33 has started distribution of a new patch.

(S11) The patch monitoring unit 141 determines whether a new patch exists. If a new patch is found, the process proceeds to step S12. If no new patch is found, the process ends.

(S12) The patch information receiving unit 142 receives specification information on the new patch. The patch information receiving unit 142 selects one node. The patch information receiving unit 142 determines whether the selected node is a patch application target. If the selected node is a patch application target, the process proceeds to step S13. If the selected node is not a patch application target, the process proceeds to step S17.

(S13) The patch job creation unit 143 determines the urgency level of the patch from the specification information.

(S14) The patch job creation unit 143 generates a patch job request for updating the OS of the node selected in step S12. The patch job request specifies the node that is a patch application target and a correction program to be executed.

(S15) The patch job creation unit 143 gives a priority corresponding to the urgency level determined in step S13 to the patch job request. For example, if the urgency level of the patch is high, the patch job creation unit 143 gives a priority indicating an urgent level to the patch job request. If the urgency level of the patch is medium or low, the patch job creation unit 143 gives a priority indicating a normal level to the patch job request.

(S16) The patch job request unit 144 transmits the patch job request generated in steps S13 to S15 to the scheduler 100.

(S17) The patch information receiving unit 142 determines whether all the nodes have been checked in step S12. If all the nodes have been checked, the process ends. If any node is yet to be checked, the process returns to step S12, where another node is selected.

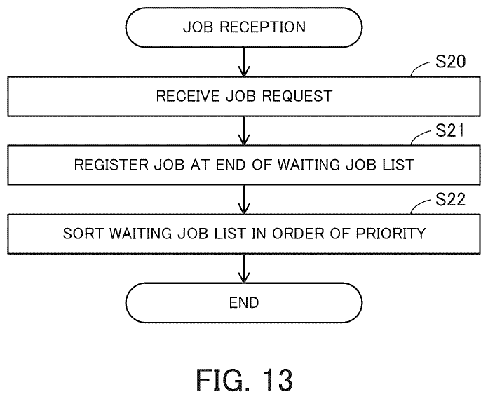

FIG. 13 illustrates an example procedure for job reception.

(S20) The job receiving unit 131 receives a job request. The received job request is the above-described patch job request or a user job request from the login server 34. The user job request specifies a user program, the number of nodes to be used, and a maximum execution time.

(S21) The job management unit 132 registers the job indicated by the job request received in step S20 at the end of the waiting job list.

(S22) The job management unit 132 sorts the jobs registered in the waiting job list in descending order of priority. In the waiting job list, jobs with the urgent level are arranged before jobs with the normal level. The jobs with the same priority level are arranged in ascending order of registration time.

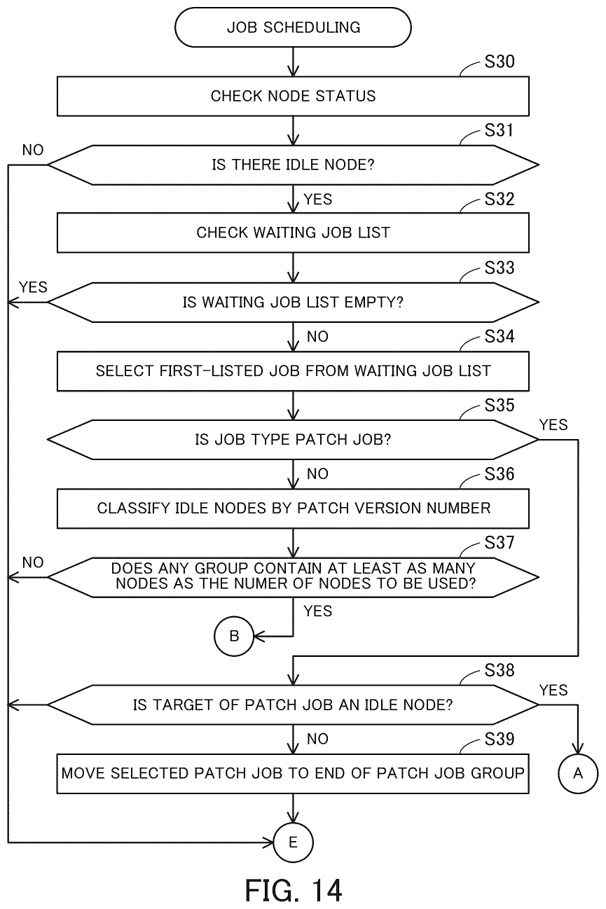

FIG. 14 illustrates a first example procedure for job scheduling.

Here, a case where the scheduler 100 selects the arrival time priority policy will be described. The process of FIGS. 14 to 16 is repeatedly performed.

(S30) The executability determination unit 135 checks the current status of nodes.

(S31) The executability determination unit 135 determines whether there are one or more idle nodes. If one or more idle nodes are detected, the process proceeds to step S32. If no idle node is detected, the process ends.

(S32) The executability determination unit 135 checks the waiting job list.

(S33) The executability determination unit 135 determines whether the waiting job list is empty. If the waiting job list is empty, the process ends. If the waiting job list is not empty, the process proceeds to step S34.

(S34) The executability determination unit 135 selects the first-listed job from the waiting job list.

(S35) The executability determination unit 135 determines whether the job type of the first-listed job selected in step S34 is patch job. If the first-listed job is a patch job, the process proceeds to step S38. If the first-listed job is a user job, the process proceeds to step S36.

(S36) The executability determination unit 135 classifies the idle nodes by patch version number. As a result, the idle nodes are classified into patched nodes and unpatched nodes.

(S37) The executability determination unit 135 determines whether the groups generated in step S36 includes a group containing at least as many nodes as the number of nodes to be used for the user job selected in step S34. If such a group is found, the process proceeds to step S52. If no such a group is found, the process ends.

(S38) The executability determination unit 135 determines whether the patch application target of the patch job selected in step S34 is an idle node. If the patch application target is an idle node, the process proceeds to step S40. If the patch application target is not an idle node, the process proceeds to step S39.

(S39) The job management unit 132 moves the patch job selected in step S34 to the end of the patch job group included in the waiting job list. Then, the process ends.

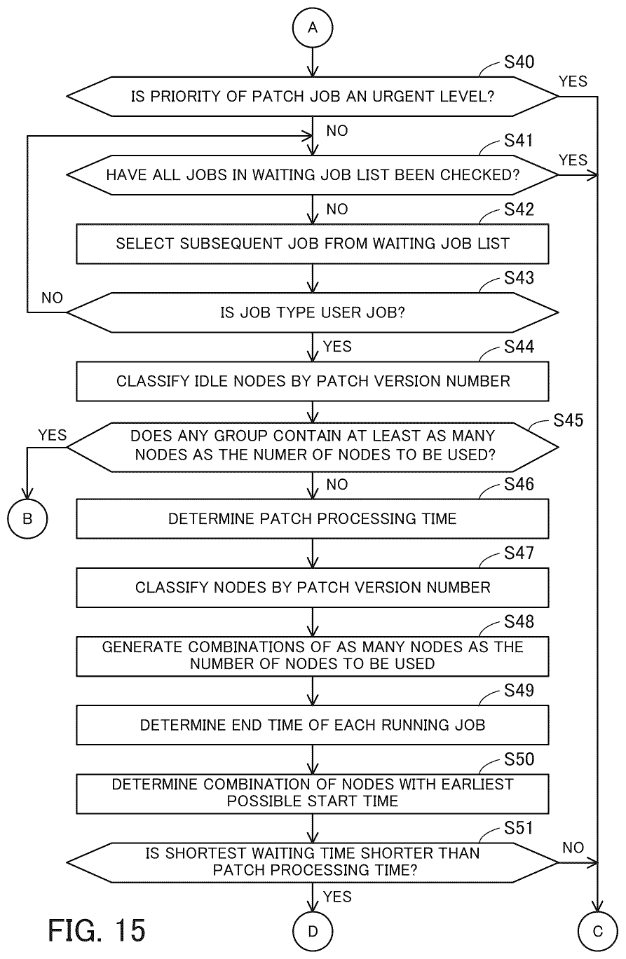

FIG. 15 illustrates the first example procedure for the job scheduling (continuation 1).

(S40) The executability determination unit 135 determines whether the priority of the patch job selected in step S34 is an urgent level. If the priority is the urgent level, the process proceeds to step S53. If the priority is not the urgent level, the process proceeds to step S41.

(S41) The executability determination unit 135 determines whether all jobs included in the waiting job list have been checked in the following step S42. If all the jobs have been checked, the process proceeds to step S53. If any job has not been checked, the process proceeds to step S42.

(S42) The executability determination unit 135 selects a subsequent job listed immediately after the currently selected job from the waiting job list.

(S43) The executability determination unit 135 determines whether the job type of the subsequent job selected in step S42 is user job. If the subsequent job is a user job, the process proceeds to step S44. If the subsequent job is a patch job, the process returns to step S41.

(S44) The executability determination unit 135 classifies idle nodes by patch version number.

(S45) The executability determination unit 135 determines whether the groups generated in step S44 includes a group that contains at least as many nodes as the number of nodes to be used for the user job selected in step S42. If such a group is found, the process proceeds to step S52. If no such a group is found, the process proceeds to step S46.

(S46) The patch time determination unit 138 determines a patch processing time for the patch job selected in step S34. The patch processing time is the execution time of a past patch of the same type or the execution time taken to apply the patch of the same version number to a node for the first time.

(S47) The start time calculation unit 136 classifies the nodes by the patch version number. The nodes classified here include both idle nodes and in-use nodes.

(S48) The start time calculation unit 136 generates one or more combinations each containing as many nodes as the number of nodes to be used for the user job selected in step S42, from a group of nodes with the same patch version number.

(S49) The end time determination unit 137 determines the end time of each running job. The end time of a user job is, for example, the time obtained by adding the maximum execution time to the start time. The end time of a patch job is the time obtained by adding the processing time to the start time.

(S50) The start time calculation unit 136 determines that the latest end time is the possible start time, for each combination of nodes generated in step S48. The start time calculation unit 136 determines a combination of nodes having the earliest possible start time and the earliest possible start time for the combination.

(S51) The executability determination unit 135 determines whether the waiting time until the earliest possible start time determined in step S50 is shorter than the patch processing time determined in step S46. If the waiting time is shorter than the patch processing time, the process proceeds to step S55. If the waiting time is greater than or equal to the patch processing time, the process proceeds to step S53.

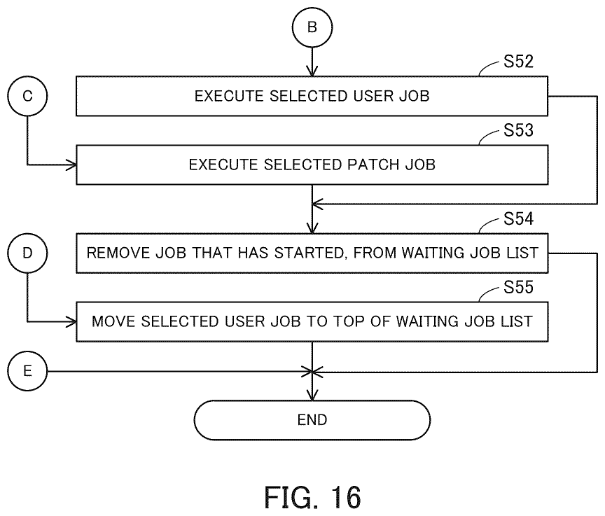

FIG. 16 illustrates the first example procedure for the job scheduling (continuation 2).

(S52) The job management unit 132 allocates, to the user job selected in step S34 or step S42, as many nodes with the same patch version number as the number of nodes to be used for the user job. The job execution unit 134 instructs the allocated nodes to execute the user job. Then, the process proceeds to step S54.

(S53) The job execution unit 134 instructs the patch application target node of the patch job selected in step S34 to execute the patch job.

(S54) The job management unit 132 removes the user job of step S52 or the patch job of step S53 from the waiting job list. Then, the process ends.

(S55) The job management unit 132 moves the user job selected in step S42 to the top of the waiting job list. As a result, the execution of the patch job is deferred, and the user job is executed as soon as the shortage of idle nodes is resolved.

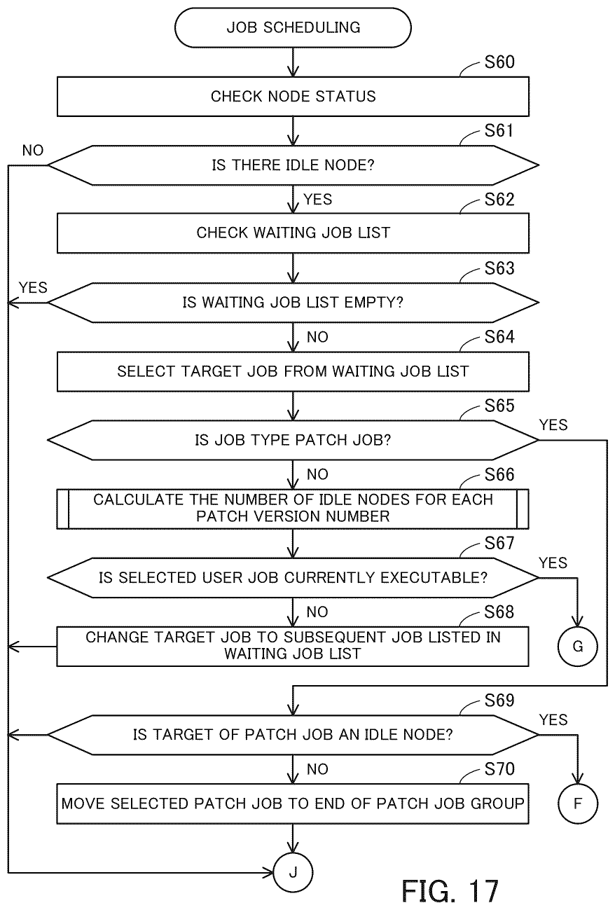

FIG. 17 illustrates a second example procedure for the job scheduling.

Here, a case where the scheduler 100 selects the executability priority policy will be described. The process of FIGS. 17 to 19 is repeatedly performed.

(S60) The executability determination unit 135 checks the current status of each node.

(S61) The executability determination unit 135 determines whether there are one or more idle nodes. If one or idle nodes are detected, the process proceeds to step S62. If no idle node is detected, the process ends.

(S62) The executability determination unit 135 checks the waiting job list.

(S63) The executability determination unit 135 determines whether the waiting job list is empty. If the waiting job list is empty, the process ends. If the waiting job list is not empty, the process proceeds to step S64.

(S64) The executability determination unit 135 selects a target job from the waiting job list. The initial value for the target job is the first-listed job in the waiting job list. However, the target job may be changed in step S68 described later.

(S65) The executability determination unit 135 determines whether the job type of the target job selected in step S64 is patch job. If the target job is a patch job, the process proceeds to step S69. If the target job is a user job, the process proceeds to step S66.

(S66) The executability determination unit 135 calculates the number of idle nodes for each patch version number in the same manner as in steps S36 and S37 described above, and compares the number of idle nodes with the number of nodes to be used for the user job selected in step S64 to determine the executability.

(S67) The executability determination unit 135 determines whether the user job selected in step S64 is currently executable. If it is executable, the process proceeds to step S83. If it is not executable, the process proceeds to step S68.

(S68) The executability determination unit 135 changes the target job to a subsequent job listed immediately after the currently selected user job in the waiting job list. Then, the process ends.

(S69) The executability determination unit 135 determines whether the patch application target of the patch job selected in step S64 is an idle node. If the patch application target is an idle node, the process proceeds to step S71. If the patch application target is not an idle node, the process proceeds to step S70.

(S70) The job management unit 132 moves the patch job selected in step S64 to the end of the patch job group included in the waiting job list. Then, the process ends.

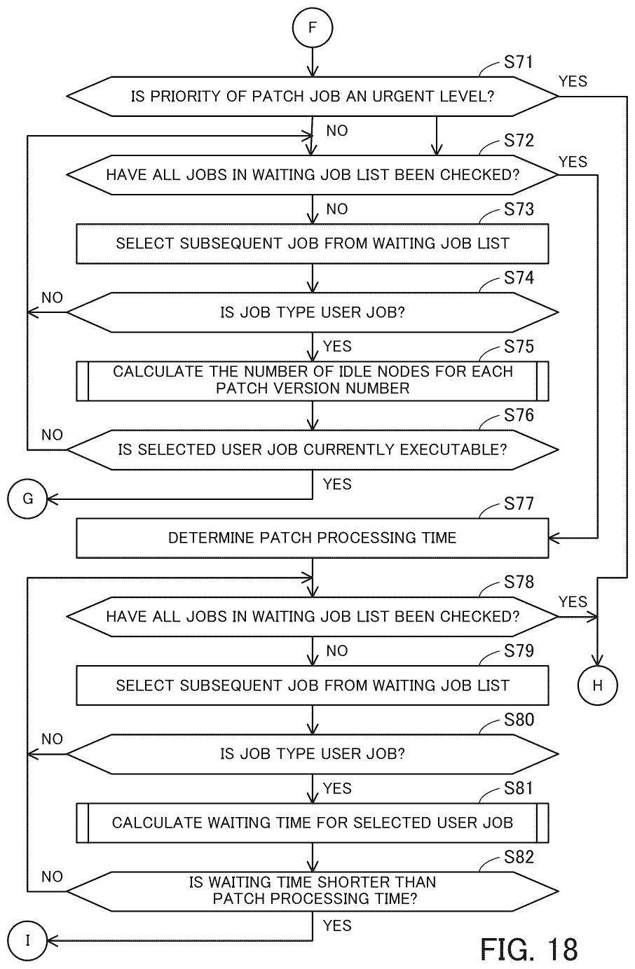

FIG. 18 illustrates the second example procedure for the job scheduling (continuation 1).

(S71) The executability determination unit 135 determines whether the priority of the patch job selected in step S64 is an urgent level. If the priority is the urgent level, the process proceeds to step S84. If the priority is not the urgent level, the process proceeds to step S72.

(S72) The executability determination unit 135 determines whether all jobs included in the waiting job list have been checked in the following step S73. If all the jobs have been checked, the process proceeds to step S77. If any job has not been checked, the process proceeds to step S73.

(S73) The executability determination unit 135 selects a subsequent job listed immediately after the currently selected job from the waiting job list. The subsequent job selected first here is a job listed immediately after the patch job selected in step S64.

(S74) The executability determination unit 135 determines whether the job type of the subsequent job selected in step S73 is user job. If the subsequent job is a user job, the process proceeds to step S75. If the subsequent job is a patch job, the process returns to step S72.

(S75) The executability determination unit 135 calculates the number of idle nodes for each patch version number in the same manner as in steps S44 and S45 described above, and compares the number of idle nodes with the number of nodes to be used for the user job selected in step S73 to determine the executability.

(S76) The executability determination unit 135 determines whether the user job selected in step S73 is currently executable. If the user job is executable, the process proceeds to step S83. If the user is not executable, the process returns to step S72.

(S77) The patch time determination unit 138 determines a patch processing time for the patch job selected in step S64. The patch processing time is the execution time of a past patch of the same type or the execution time taken to apply the patch of the same version number to a node for the first time.

(S78) The executability determination unit 135 determines whether all jobs included in the waiting job list have been checked in the following step S79. If all the jobs have been checked, the process proceeds to step S84. If any job has not been checked, the process proceeds to step S79.

(S79) The executability determination unit 135 selects a subsequent job listed immediately after the currently selected job from the waiting job list. The subsequent job selected first here is a job listed immediately after the patch job selected in step S64.

(S80) The executability determination unit 135 determines whether the job type of the subsequent job selected in step S79 is user job. If the subsequent job is a user job, the process proceeds to step S81. If the subsequent job is a patch job, the process returns to step S78.

(S81) The start time calculation unit 136 calculates the earliest possible start time for the user job selected in step S79 in the same manner as in step S48 described above, and calculates the waiting time from the present time to the earliest possible start time.

(S82) The executability determination unit 135 determines whether the waiting time calculated in step S81 is shorter than the patch processing time determined in step S77. If the waiting time is shorter than the patch processing time, the process proceeds to step S86. If the waiting time is longer than or equal to the patch processing time, the process returns to step S78.

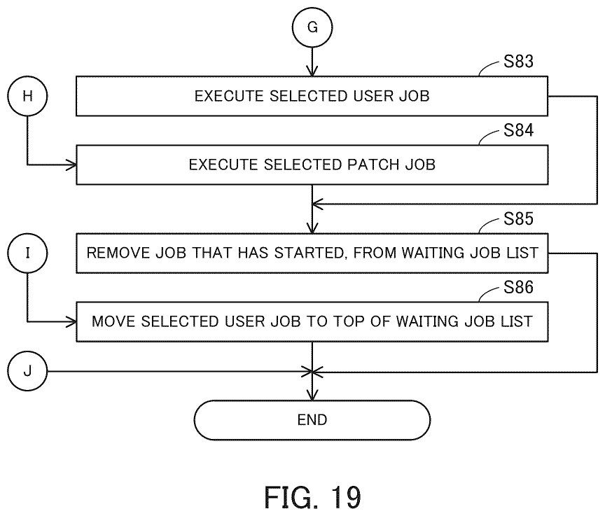

FIG. 19 illustrates the second example procedure for the job scheduling (continuation 2).

(S83) The job management unit 132 allocates, to the user job selected in step S64 or step S73, as many idle nodes with the same patch version number as the number of nodes to be used for the user job. The job execution unit 134 instructs the allocated nodes to execute the user job. Then, the process proceeds to step S85.

(S84) The job execution unit 134 instructs the patch application target node of the patch job selected in step S64 to execute the patch job.

(S85) The job management unit 132 removes the user job of step S83 or the patch job of step S84 from the waiting job list. Then, the process ends.

(S86) The job management unit 132 moves the user job selected in step S79 to the top of the waiting job list. As a result, the execution of the patch job is deferred, and the user job is executed as soon as the shortage of idle nodes is resolved.

As described above, the scheduler 100 of the second embodiment does not execute a patch job on all nodes at the same time, but allows the patch job to be executed on the nodes at different start times. Accordingly, the administrator does not need to stop the operation of the information processing system, which improves the availability of the information processing system. The scheduler 100 allocates nodes having OSs with the same patch version number to a user job that uses two or more nodes. As a result, errors caused by differences in patch version number are prevented.

Even in the case where a patch job at the top of the waiting job list is immediately executable and its subsequent user job is not immediately executable, the scheduler 100 may temporarily defer the patch job and wait until the user job becomes executable. At this time, the scheduler 100 estimates the earliest possible start time for the subsequent user job, and if the waiting time until the earliest possible start time is shorter than the processing time of the patch job, increases the priority of the user job. Thus, a delay in the start time of the user job due to the influence of the patch job is prevented, and the waiting time of the user job is thus reduced.

In one aspect, the waiting time of a user job is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
identifying, from among a plurality of execution waiting jobs, an update job for updating control software on a target node among a plurality of nodes and a user job specifying a number of nodes to be used among the plurality of nodes;
calculating, based on a version of the control software on each of the plurality of nodes and a scheduled end time of each of one or more running jobs being executed on the plurality of nodes, a possible start time at which a number of idle nodes having a same version of the control software among the plurality of nodes becomes greater than or equal to the number of nodes to be used; and
determining, based on a processing time needed to execute the update job and the possible start time, whether to prioritize execution of the update job or the user job.

2. The non-transitory computer-readable storage medium according to claim 1, wherein the update job is at a top of an execution waiting queue including the plurality of execution waiting jobs, and the user job is listed after the update job in the execution waiting queue.

3. The non-transitory computer-readable storage medium according to claim 1, wherein the determining includes determining that the user job is to be executed preferentially over the update job, upon determining that a waiting time until the possible start time is shorter than the processing time.

4. The non-transitory computer-readable storage medium according to claim 1, wherein the calculating includes determining, upon determining that the one or more running jobs include another update job for updating the control software on another target node among the plurality of nodes, the idle nodes having the same version based on a change in the version of the control software on said another target node resulting from execution of said another update job.

5. A job scheduling method comprising:
identifying, by a processor, from among a plurality of execution waiting jobs, an update job for updating control software on a target node among a plurality of nodes and a user job specifying a number of nodes to be used among the plurality of nodes;
calculating, by the processor, based on a version of the control software on each of the plurality of nodes and a scheduled end time of each of one or more running jobs being executed on the plurality of nodes, a possible start time at which a number of idle nodes having a same version of the control software among the plurality of nodes becomes greater than or equal to the number of nodes to be used; and
determining, based on a processing time needed to execute the update job and the possible start time, whether to prioritize execution of the update job or the user job.

6. An information processing apparatus comprising:
a memory configured to store job information indicating a plurality of execution waiting jobs including an update job for updating control software on a target node among a plurality of nodes and a user job specifying a number of nodes to be used among the plurality of nodes; and
a processor coupled to the memory and the processor configured to:
calculate, based on a version of the control software on each of the plurality of nodes and a scheduled end time of each of one or more running jobs being executed on the plurality of nodes, a possible start time at which a number of idle nodes having a same version of the control software among the plurality of nodes becomes greater than or equal to the number of nodes to be used; and
determine, based on a processing time needed to execute the update job and the possible start time, whether to prioritize execution of the update job or the user job.

7. The information processing apparatus according to claim 6, wherein the update job is at a top of an execution waiting queue including the plurality of execution waiting jobs, and the user job is listed after the update job in the execution waiting queue.

8. The information processing apparatus according to claim 6, wherein the processor is configured to determine that the user job is to be executed preferentially over the update job, upon determining that a waiting time until the possible start time is shorter than the processing time.

9. The information processing apparatus according to claim 6, wherein, in calculating the possible start time, the processor is configured to determine, upon determining that the one or more running jobs include another update job for updating the control software on another target node among the plurality of nodes, the idle nodes having the same version based on a change in the version of the control software on said another target node resulting from execution of said another update job.
